(19) United States
(12) Patent Application Publication
(10) Pub. No.: US 2026/0211403 A1
(43) Pub. Date: Jul. 23, 2026

(54) Engineering System and Computer-Implemented Method for Generating a Plant Image Hierarchy for Operating and Observing a Process Plant

(71) Applicant: Siemens Aktiengesellschaft, Muenchen (DE)

(72) Inventor: Benjamin LUTZ, Pfinztal (DE)

(21) Appl. No.: 19/141,225

(22) PCT Filed: Nov. 3, 2023
(86) PCT No.: PCT/EP2023/080657

§ 371 Date: Jun. 19, 2025

(30) Foreign Application Priority Data
Dec. 22, 2022 (EP) 22216043.4

(51) Int. Cl. G05B 19/418

(52) U.S. Cl. CPC G05B 19/41865; G05B 2219/40444

(57) ABSTRACT

A plant image hierarchy, in which plant images for operating and observing a process plant to be controlled are stored in a structured, selectable and openable manner by an operator at the runtime of the plant, is intended to be generated efficiently and with little susceptibility to errors, wherein hierarchy information relating to a plant image of a first hierarchical level and sequence information (RI) relating to a sequence with respect to other plant images of a second hierarchical level, which are assigned to the same plant image of the first hierarchical level, is assigned to at least some of the plant images before the structured storage, and these plant images are then output in a pre-structured form for subsequent structured interconnection, where the plant images are preferably plant images of modularized and preconfigured process plant parts (package units) in hybrid process plants, such as module type packages (MTPs).

### CROSS-REFERENCE TO RELATED APPLICATIONS

This is a U.S. national stage of application No. PCT/EP2023/080657 filed 3 Nov. 2023. Priority is claimed on European Application No. 22216043.4 filed 22 Dec. 2022, the content of which is incorporated herein by reference in its entirety.

### BACKGROUND OF THE INVENTION

### 1. Field of the Invention

The invention relates to an engineering system and a computer-implemented method for generating a plant image hierarchy for operating and observing a process engineering plant.

### 2. Description of the Related Art

For operating and observing large process engineering plants, operators (i.e., persons responsible for operating and observing the plant) are presented with symbolic plant images that abstractly represent the process engineering relationships, i.e., between objects of a process running in the plant (hereinafter referred to as “process objects”).

Plant images include, for example, static symbols (for example, lines, and/or rectangles), dynamic symbols (for example, lines with color changes depending on process values, or rectangles with fill levels), block symbols (for dynamic visualization of process engineering process objects), symbols for operating dialogs (for example, “faceplates”), complex controls (for example, trend displays, and/or message sequence displays) and containers for visualizing content from independent and autonomous sources (for example, plant images of modular plant components (package units), apps (for example, controller optimizers, KPI calculations)).

EP 3 623 891 A1 discloses the use of “plant image hierarchies” for navigating between plant images in an operator-station-client for operating and observing a plant by operators, i.e., the plant images provided for operating and observing are offered to the operator via a hierarchical (expandable and collapsible) tree structure. The plant images can be selected and opened during runtime of the technical plant using this tree structure.

Each node in the image hierarchy references a plant image and a “group alarm status”. The group alarm status represents the alarm status of the respective plant image, i.e., all alarms of the process objects in a plant image are summarized separately according to alarm classes and displayed in the image hierarchy. This allows an operator of a control system for the technical plant when viewing the image hierarchy to immediately see which plant image contains alarm-triggering process objects. Using a “loop-in”, the operator can navigate directly to these process objects. This is even possible if the process object is not recognizable in the case of a compact image hierarchy.

The image hierarchy is statically planned in an engineering environment of the control system of the technical plant and often contains numerous plant images, sometimes several hundred. For reasons of clarity, the image hierarchy is therefore usually only displayed in a compact mode during the runtime of the technical plant. In order to be able to navigate more efficiently between the images that are individually most important for each operator of the control system, it is possible in addition to the static image hierarchy planned in the engineering to also provide an image hierarchy that can be dynamically customized during the runtime. The operator can create, optimize, and maintain this hierarchy themselves during the runtime of the technical plant using a customization service in order to be able to navigate efficiently between their favorite plant images. This enables the operator to identify alarm causes more quickly, for example.

In the plant image hierarchy, plant images for operating and observing a process engineering plant to be controlled are stored in a structured manner with regard to hierarchy and sequence and can be selected and opened by an operator during the runtime of the plant. In the structured storage, the plant image hierarchy comprises at least a first (higher) and a second (lower) hierarchy level, where plant images of the second hierarchy level are assigned to a plant image of the first hierarchy level and in each case plant images of the second hierarchy level assigned to the same plant image of the first hierarchy level are in turn assigned to a sequence, in particular to a sequence with regard to a process engineering structure of the plant. A plant image hierarchy of this type is known, for example, from US Pub. No. 2019 137962 A1.

The plant image hierarchy is usually created in engineering by a project engineer using a special plant image hierarchy editor, where the plant image hierarchy often resembles the structure of the technological hierarchy. This often involves several hundred plant images for operating and observing process engineering plants. All existing plant images are displayed in the plant image hierarchy editor on the same level, i.e., in a flat list. Consequently, the project planning of the plant image hierarchy is complex and potentially error-prone. According to the current state of technology, this does not change even if increasingly modularized and pre-configured plant components (package units) are used, which usually also provide multiple plant images. In the case of new plant concepts, such plant components are flexibly integrated into the plant or removed again. When integrating a new package unit with new plant images, all newly added plant images must then be inserted individually into the hierarchy. Modularized and pre-configured plant components (package units) are known, for example, from US Pub. No. 2022/0147025 A1.

### SUMMARY OF THE INVENTION

In view of the foregoing, it is an object of the present invention is to provide a system and method that enable a more efficient and less error-prone generation of plant image hierarchies.

This and other objects and advantages are achieved in accordance with the invention by a computer-implemented method and an engineering system, a computer program that comprises commands which when implementing the program by a computer cause the computer to perform the method, and by a computer-readable storage medium comprising commands which when executed by a computer cause the computer to perform the method.

The method in accordance with the invention is used to generate a plant image hierarchy, in which plant images for operating and observing a process engineering plant to be controlled are stored in a structured manner with regard to hierarchy and sequence and can be selected and opened by an operator during the runtime of the plant, where in the structured storage:
the plant image hierarchy comprises at least a first (higher) and a second (lower) hierarchy level,
plant images of the second hierarchy level are assigned to a plant image of the first hierarchy level,
plant images of the second hierarchy level assigned to the same plant image of the first hierarchy level are assigned to a sequence, i.e., a sequence with regard to a process engineering structure of the plant.

In accordance with the invention, the method comprises:
a) assigning to at least some of the plant images of the second hierarchy level in each case
   hierarchy information with regard to a plant image of the first hierarchy level, and
   sequence information with regard to a sequence with regard to other plant images of the second hierarchy level which are assigned to the same plant image of the first hierarchy level, i.e., a sequence with regard to a process engineering structure of the plant, where this assignment occurs prior to the structured storage of the plant images,
b) outputting the plant images for selection (for example, to a project engineer of the plant image hierarchy),
c) recording selection information (for example, by a project engineer of the plant image hierarchy) with regard to a selection of the plant images output in step b) for subsequent structured interconnection with each other with regard to hierarchy and sequence, and
d) outputting the plant images selected in step c) for their subsequent structured interconnection, where plant images with assigned hierarchy information and sequence information are automatically pre-structured according to the respective assigned hierarchy information and sequence information.

Due to the pre-structuring of the plant images using hierarchy and sequence information, the subsequent structured interconnection and thus the project planning of the plant image hierarchy can be implemented with significantly less effort and less susceptibility to errors. In the best case, the pre-structuring is already so complete and correct that no subsequent additional interconnection of plant images is necessary at all.

These advantages are particularly evident when using modularized and pre-configured process engineering plant components (often referred to as “package units”). Examples of such plant components are the “module type packages” (MTPs), as defined, for example, by NAMUR (Interessengemeinschaft Automatisierungstechnik der Prozessindustrie e.V.) in the VDI/VDE/NAMUR 2658 standard and used, for example, in hybrid process engineering plants. They can be flexibly integrated into a process engineering process or removed again. Such plant components often provide multiple plant images, which must be integrated into the plant image hierarchy when they are incorporated into a process. At least some of the plant images with the associated hierarchy and sequence information therefore refer to a modularized and pre-configured process engineering plant component, in particular a Module Type Package (MTP).

In accordance with an advantageous embodiment, the plant images are defined by a technological (i.e., process engineering) hierarchy of the plant or are provided by this hierarchy.

In accordance with a further particularly advantageous embodiment, the plant images are output in step b) in a structured manner according to the technological hierarchy of the plant. This further increases clarity when selecting plant images and thus efficiency when generating the plant image hierarchy.

The plant image hierarchy is advantageously generated in an engineering system, where the hierarchy and sequence information is preferably assigned when importing plant images into the engineering system.

The hierarchy and sequence information can be assigned manually by a project engineer or automatically based on structural information that is already supplied with the plant images, as may be the case, for example, with modularized and pre-configured process engineering plant components.

In a very user-friendly embodiment, the selection information is defined by a move operation that can be performed by a project engineer, for example, a graphical drag operation or a copy and paste operation.

In order to further increase the efficiency when generating the plant image hierarchy, only plant images that are not yet contained in the plant image hierarchy can be output for selection in step b).

An engineering system in accordance with the invention is used to generate a plant image hierarchy, in which plant images for operating and observing a process engineering plant to be controlled are stored in a structured manner with regard to hierarchy and sequence and can be selected and opened by an operator during the runtime of the plant, where within the structured storage:
the plant image hierarchy comprises at least a first and a second hierarchy level,
plant images of the second hierarchy level are assigned to a plant image of the first hierarchy level,
plant images of the second hierarchy level assigned to the same plant image of the first hierarchy level are assigned to a sequence, i.e., a sequence with regard to a process engineering structure of the plant, comprises at least one processor which is connected to a storage device, where the at least one processor is configured so that it performs the above-described method.

The advantages mentioned for the method in accordance with the invention apply accordingly to the engineering system in accordance with the invention.

A computer program in accordance with the invention comprises commands which, when implementing the program by a computer, cause the computer to perform the above-described method.

A computer-readable storage medium in accordance with the invention comprises commands which, when executed by a computer, cause the computer to perform the above-described method.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and further advantageous embodiments of the invention are explained in more detail below with the aid of exemplary embodiments shown in the figures, in which:

FIG. 1 shows an industrial plant with an automation system featuring an engineering system in accordance with the invention;

FIG. 2 shows generation of a plant image hierarchy with a plant image hierarchy editor in accordance with the prior art;

FIG. 3 shows an object model for the generation in accordance with the invention of a plant image hierarchy;

FIGS. 4-7 show a generation in accordance with the invention of a plant image hierarchy with a plant image hierarchy editor; and

FIG. 8 shows a flowchart of the method sequence in accordance with the invention.

### DETAILED DESCRIPTION OF THE INVENTION

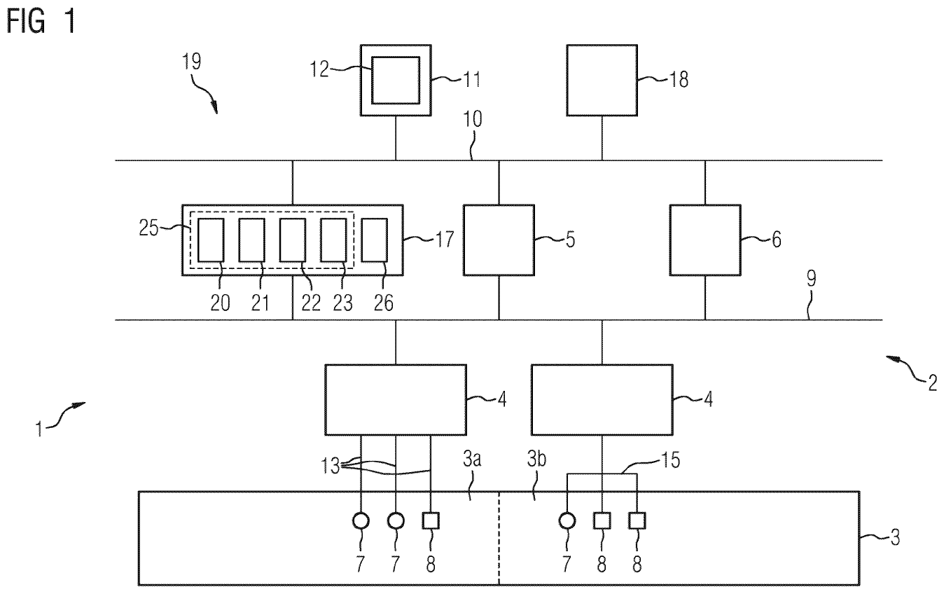

FIG. 1 shows a simplified representation of an industrial plant 1 with an industrial automation system 2. Such plants 1 are used in a wide variety of industrial sectors, for example in the process industry (for example, chemical, pharmaceutical, metal, oil and gas, paper), discrete manufacturing, and energy generation. The actual industry-specific process 3, for example, a production or energy generation process, is controlled and/or regulated and monitored by the automation system 2. The automation system 2 comprises one or more industrial controllers (here the controllers 4) and two or more automation servers 5, 6, which are often also referred to as “application servers” or “operator station servers.”

Each of the controllers 4 then controls the operation in each case of one sub-process 3a or 3b of process 3 depending on its operating states, where the sub-processes 3a, 3b are connected in series in a process engineering process flow direction, i.e., the sub-process 3b is downstream of sub-process 3a. The process 3 comprises actuators 7 that can be controlled by the controllers 4. These can be individual actuators (for example, a motor, a pump, a valve, a switch), or groups of such actuators, or entire sections of a plant. The process also includes sensors 8, which provide the controllers 4 with actual values of process variables (for example, temperatures, pressures, speeds). The automation server 5 is assigned to the sub-process 3a and the automation server 6 is assigned to the sub-process 3b. The automation system 2 without the field devices (i.e., without actuators 7 and sensors 8) is often referred to as a “process control system”.

A communication network of the plant 1 comprises, at a higher level, a plant network 10 (for example, an industrial Ethernet network) via which the automation servers 5, 6 communicate with an operating and observing station 18, often also referred to as an “operator station client”, and a control network 9 (for example, an industrial Ethernet network) via which the controllers 4 are in communication with each other and with the automation servers 5, 6. The controllers 4 can be connected to the actuators 7 and sensors 8 via discrete signal lines 13 or via a fieldbus 15.

The automation servers 5, 6 store one or more plant-specific application programs that are executed during operation of plant 1. These are used, for example, to configure the controllers 4 in plant 1, to record and execute operator activities at the operating and observing station 18 (for example, to set or change set points for process variables) or to generate messages for plant personnel and display them on the operating and observing station 18.

The automation system 2 also includes an engineering server 17 and an engineering client 11, which are also connected to the plant network 10. The engineering server 17 and the engineering client 11 form an engineering system 19 for creating and project planning the plant-specific application programs in the automation servers 5, 6.

Additional operator station clients, not shown, and/or engineering clients as well as additional engineering servers, archive servers, and/or batch systems, can be present and connected to the plant network 10.

The servers 5, 6, 17 each comprise a web server that provides web applications. A web browser is installed and executes on the operating and observing station 18 and the engineering station 11; the web browser can be connected or is connected in terms of communication to the web servers of the servers 5, 6, 17 via the network 10.

The engineering system 19 is used to generate and configure the plant-specific application programs in the automation servers 5, 6. This includes the creation of a technological (i.e., process engineering) hierarchy 20 of the plant using suitable software of the engineering system 19. This technological hierarchy 20 is often referred to as the “equipment hierarchy” and is stored in a storage device 25 of the engineering server 17. In this technological hierarchy 20, process objects such as measuring points, tanks, valves, sensors, actuators, continuous function charts (CFCs), and sequential function charts (SFCs) are entered or stored structured in accordance with a tree structure. After creation, the technological hierarchy 20 is compiled by the engineering system 19 and then loaded into the automation servers 5, 6 and thus into the runtime environment of the automation system 2. The technological hierarchy 20 then forms the basis for a process image in the automation servers 5, 6, which contains the data structures of the process objects assigned to the respective automation server.

For the purpose of operating and observing the plant 1, various plant images are displayed to an operator on a graphical user interface of the operator station client 18 by the application servers 5, 6 during the runtime of plant 1. “plant image hierarchies” are used to navigate between the plant images, i.e., the plant images intended for operating and observing are presented in a hierarchical (expandable and collapsible) tree structure. The plant images can be selected and opened by an operator during the runtime of the technical plant using this tree structure.

Each node in the image hierarchy references a plant image and preferably also a “group alarm status”. The group alarm status represents the alarm status of the respective plant image, i.e., all alarms of the process objects in a plant image are summarized separately according to alarm classes and displayed in the image hierarchy. This allows an operator of the automation system 2 of the plant 1 when viewing the image hierarchy to immediately see which plant images contain alarm-triggering process objects. Using a “loop-in”, the operator can navigate directly to these process objects. This is even possible if the process object is not recognizable in a compact image hierarchy.

The engineering system 19 is also used to (statically) generate or plan the plant image hierarchy 21 and to store associated hierarchy information in the storage device 25. For this purpose, the engineering system 19 comprises a special plant image hierarchy editor 22, which is also stored as a program in the storage device 25 of the engineering server 17. The engineering server 17 further comprises at least one processor 26, which is connected to the storage device 25 and is configured to execute the below-described method for generating the plant image hierarchy 21.

Several hundred plant images are often required for operating and observing the plant 1. As a result, generating the plant image hierarchy 21 in the prior art is time-consuming and error-prone.

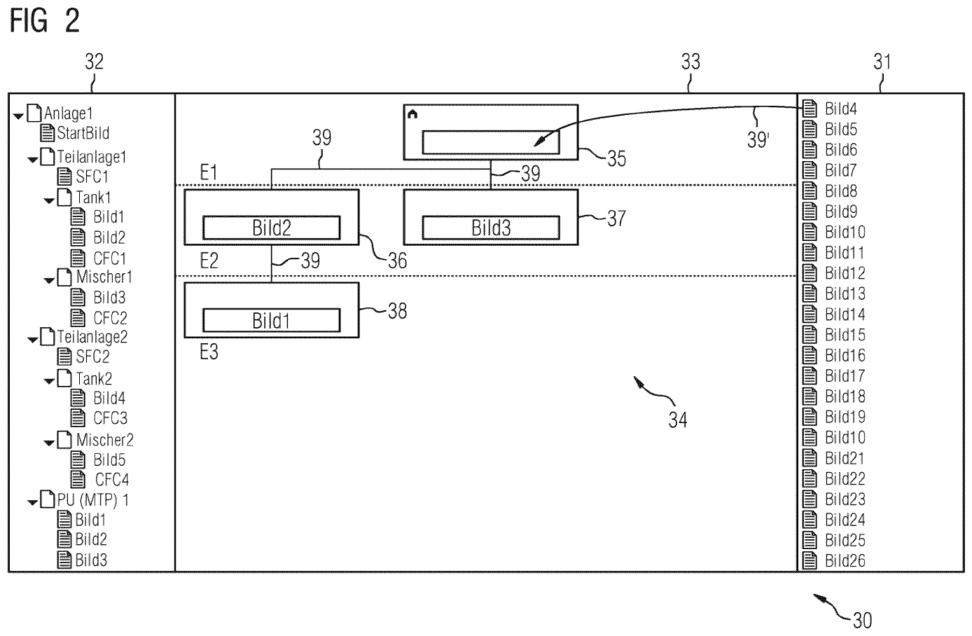

FIG. 2 shows an example of a graphical output 30 of a plant image hierarchy editor 22 on a display 12 of the engineering client 11 in accordance with the prior art. The graphical output comprises three areas 31, 32, 33.

The technological hierarchy 20 of the plant 1 with the various process objects is shown in a left-hand area 32. In the exemplary embodiment, the technological hierarchy at a first top level comprises the plant 1 as “Plant1” with an assigned plant image “StartImage.” At a second hierarchy level below, the plant 1 is subdivided into a “Subplant1,” a “Subplant2,” and a package unit “PU(MTP)1.” These are then assigned plant components such as a first tank “Tank1,” a first mixer “Mixer1,” a second tank “Tank2,” and a second mixer “Mixer2,” each with process objects hierarchically subordinate to them, such as plant images (Image1, Image2, Image3, etc.) and/or continuous flow charts CFC1, CFC2, CFC3.

In the prior art, in the area 31, a project engineer is presented with all plant images available in the technological hierarchy 20, here excerpts from image4-Image26, on the same level in a flat list for selection.

The area 33 of the plant image hierarchy editor 22 is used by a project engineer to create a plant image hierarchy 34.

To do this, the project engineer must select the individual plant images in the area 31 by clicking on them, move them to area 33 using a graphical drag & drop operation (symbolized by arrow 39′), arrange them there, and connect them to other plant images in a structured manner to form the plant image hierarchy 34 (symbolized by the connections 39). Advantageously the connections 39 are automatically generated in a particularly simple manner by dragging and dropping a selected plant image onto a plant image in the area 33. This subordinates this selected plant image to the plant image on which it is placed.

Here, the plant image hierarchy 34 under the start image 35 comprises a first hierarchy level E1, a second hierarchy level E2 below it, and a third hierarchy level E3 below that.

The plant images 36, 37, 38 are each assigned to a plant image of a higher hierarchy level, in this case the plant images 36, 37 of the second hierarchy level E2 to the plant image 35 of the first hierarchy level E1 and the plant image 38 of the third hierarchy level E3 to the plant image 36 of the second hierarchy level E2.

The plant images 36, 37, which are on the same level, are assigned to a sequence of the technological method structure. For example, plant image 36 refers to the sub-process 3a and plant image 37 refers to the subsequent sub-process 3b according to FIG. 1. The plant images 36, 37 are therefore arranged from left to right in the sequence of the process engineering process 3.

However, selecting the plant images in the area 31 and arranging and interconnecting them in the area 33 is time-consuming and potentially error-prone.

To reduce this effort and the susceptibility to errors, the plant images are pre-structured prior to this structuring process in accordance with the invention.

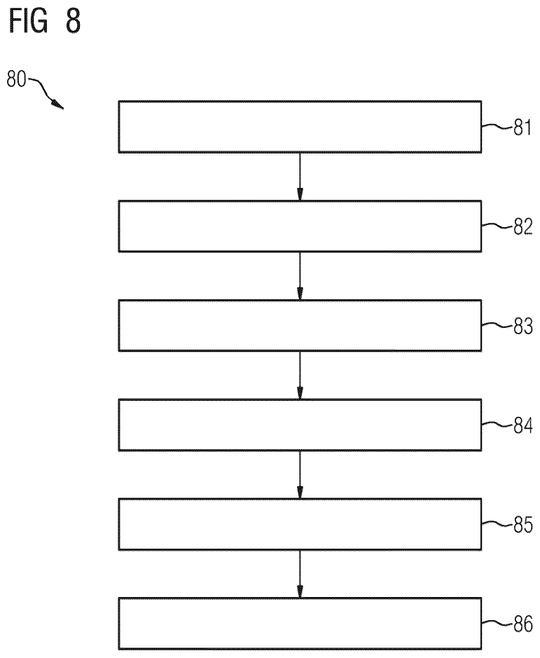

The method in accordance with the invention for pre-structuring is to be illustrated with the aid of a method sequence 80 shown in FIG. 8:

In a first step 81, the engineering system 19, for at least some of the plant images of the second and lower hierarchy levels E2, E3, prior to the actual structured storage (in other words, structuring by interconnection) by a project engineer, already records in each case hierarchy information with regard to a plant image of a higher hierarchy level and sequence information with regard to a sequence with regard to other plant images each assigned to the same hierarchy level and stores it in the storage device 25. Here, the sequence relates to the process engineering structure of the plant 1.

This information can be recorded automatically when plant images are imported into the engineering system 19, for example, by requesting a project engineer to enter data on the engineering client 11, or manually at a later point in time by the project engineer. In the case of modular, pre-structured plant components that provide plant images, the structural information on hierarchies and sequences of these plant images already provided (supplied) by these plant components is automatically taken into account.

In a second step 82, this hierarchy and sequence information is stored in the storage device 25 of the engineering server 17.

In a third step 83, the plant images are output to a project engineer in the area 31 of the editor 21 for selection. Preferably, the plant images are output in the same structure as shown in the technological hierarchy of plant 1 in the area 32.

In a fourth step 84, selection information is recorded by the project engineer with regard to a selection of the plant images output in the third step 83 in the area 31. This selection is used for their subsequent structured interconnection with regard to hierarchy and sequence.

In a fifth step 85, the plant images selected in the fourth step 84 are output to the project engineer in the area 33 of the editor 21 for their subsequent structured interconnection. The selected plant images to which hierarchy information and sequence information is assigned are automatically pre-structured with regard to hierarchy and sequence in the area 33 in accordance with this assigned information.

This pre-structuring can then be corrected or supplemented as required in a sixth step 86, thus completing the plant image hierarchy 21.

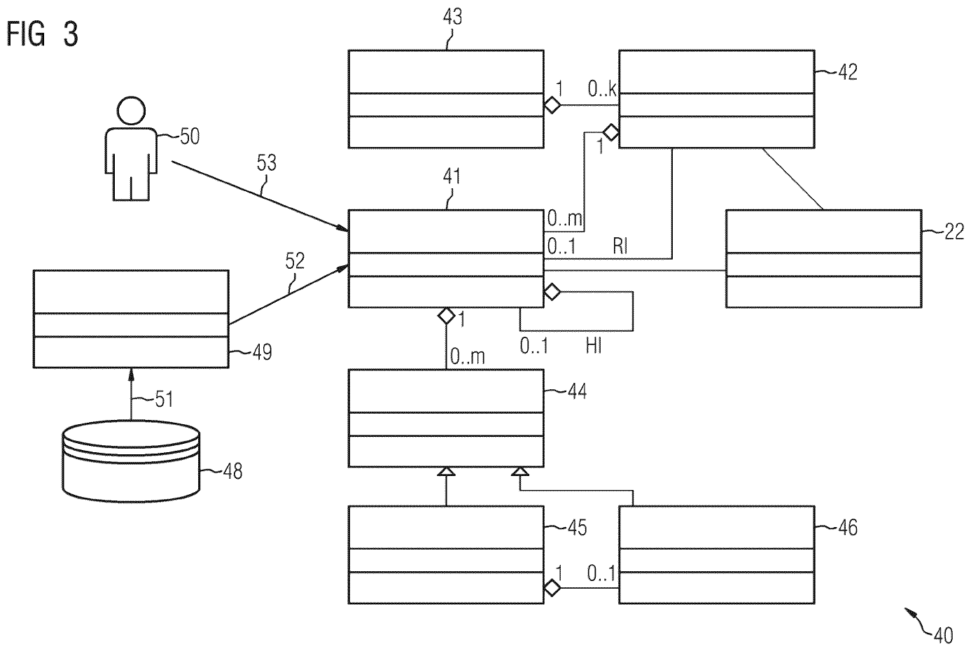

FIG. 3 shows a possible associated object model 40 in the engineering server 17.

The central components are the various plant images 41, each of which is assigned graphical objects 44 that include, for example, block symbols 45 and faceplates 46. The plant image hierarchy is defined by a structure folder 42, which in turn is assigned to a specific plant project 43. The plant image hierarchy is defined using the (in accordance with the invention, extended) plant image hierarchy editor 22. In accordance with the invention, hierarchy information HI and sequence information RI as explained above can be assigned to each of the plant images 41. The pre-structured plant images 41 can still be planned by a project engineer 50 (symbolized by an arrow 53). However, this can also be done when importing a description 48 of a modularized, pre-configured process engineering plant component (package unit), which also contains a description of the plant images to be generated and their relationship to each other. A special package unit import/export editor 49 can be used for this purpose, which reads the description 48 of the package unit (symbolized by an arrow 51) and generates the plant images with the hierarchy information HI and sequence information RI (symbolized by an arrow 52).

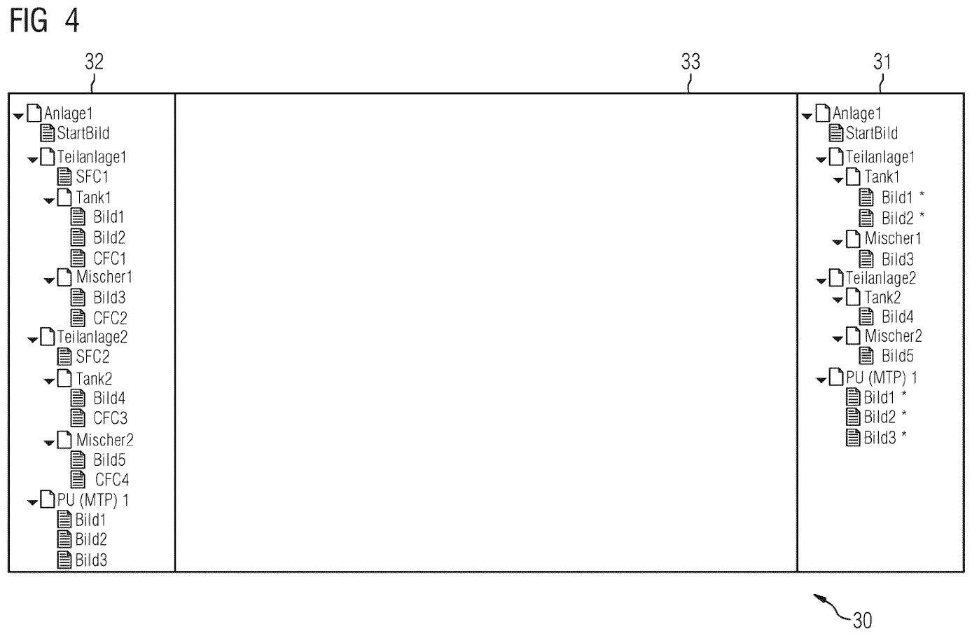

FIGS. 4-7 show an exemplary embodiment of working in accordance with the invention with the (extended) plant image hierarchy editor 22.

FIG. 4 shows the technological hierarchy of plant 1 in the left-hand area 32 as in the area 32 of FIG. 1. In the area 31, the plant images of the plant that are not yet assigned to the plant image hierarchy in the area 33 are now output according to the technological structuring. The images marked with an asterisk “*” are each assigned hierarchy and sequence information (here Image1, Image2 from Tank1 and Image1, Image2, Image3 from PU(MTP)1), i.e., these plant images are already pre-structured.

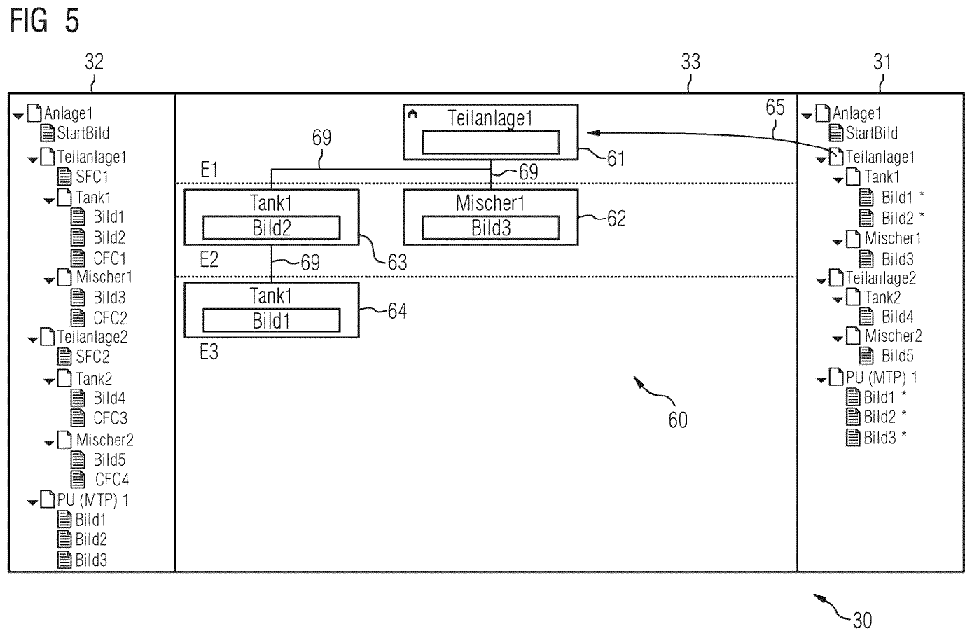

In accordance with FIG. 5, the plant images of the area 31 can now be selected by clicking on them and can then be placed in the area 33 using drag & drop (symbolized by an arrow 65) and interconnected to form a plant image hierarchy 60. E1, E2, and E3 denote the different hierarchy levels of the plant image hierarchy 60.

In the case of FIG. 5, for example, plant images 63 “Image2” and 64 “Image” were selected from plant component “Tank1” and the plant image 62 “Image3” was selected from the plant component “Mixer1” by clicking on the respective higher-level structure node and placed in the area 33 using drag & drop.

If there are pre-structured plant images below, this structuring is automatically taken into account by the plant image hierarchy editor 22, as shown here for plant images 63 “Image2” and 64 “Image1” of the component “Tank1”. Although these two plant images 63, 64 are on the same level in the technological hierarchy, the pre-structuring renders it possible to specify that, for example, plant image 64 “Image1” is subordinate to plant image 63 “Image2”.

The pre-structured plant images 63, 64 and the plant image 62 “Image3” of the component “Mixer1” can be subordinated in the hierarchy under the plant image 61 by selecting the respective higher-level structure node in the area 31 and then placing it directly on the plant image 61 using drag & drop. This automatically creates the interconnection symbolized by the connecting lines 69. Alternatively, this can be performed in the editor 22 by a project engineer by creating a connection manually.

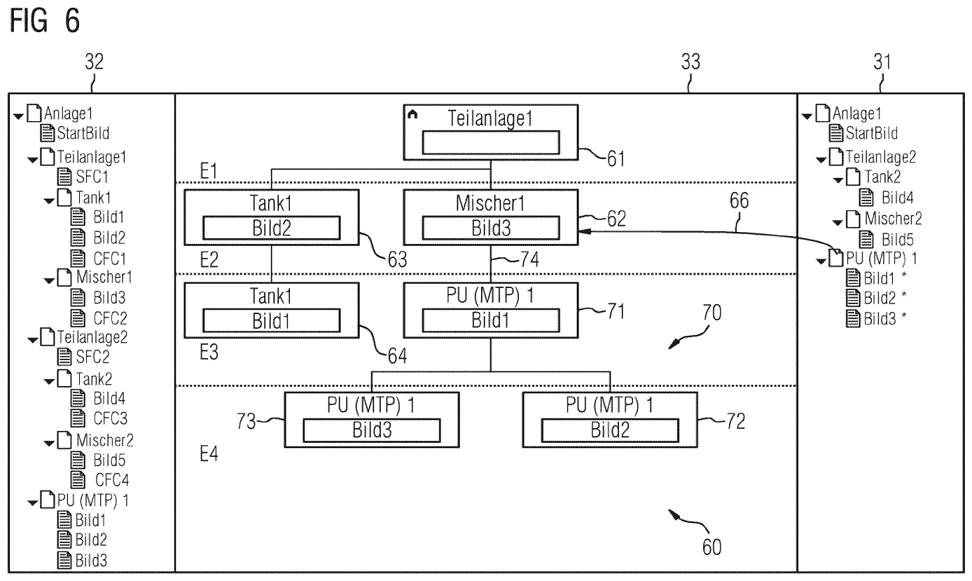

As FIG. 6 shows, only plant images that have not yet been used in the hierarchy 60 are displayed for selection in the area 31. The further generation or project planning of the plant image hierarchy 60 can thus be performed very efficiently.

In the case of package unit PU(MTP)1, it is now assumed that, after being imported into the engineering system 19, it is pre-structured also using hierarchy and sequence information, here plant images Image3 and Image2 are each subordinate to Image1, where Image3 precedes Image2 in the process engineering sequence.

If these plant images of the package unit PU(MTP)1 are now selected by clicking and dragging and dropping the higher-level structure node PU(MTP)1 and placed in the area 33, they are output in the area 33 in accordance with this pre-structuring (see plant images 71, 72, 73 in FIG. 6). The project engineer now only has to interconnect these to the existing plant image hierarchy 60, in this case, for example, subordinate them to plant image 62, symbolized by the connecting line 74. This interconnecting is particularly advantageous because it is already performed automatically by selecting the higher-level structure node PU(MTP)1 and placing it directly in plant image 62 using drag & drop.

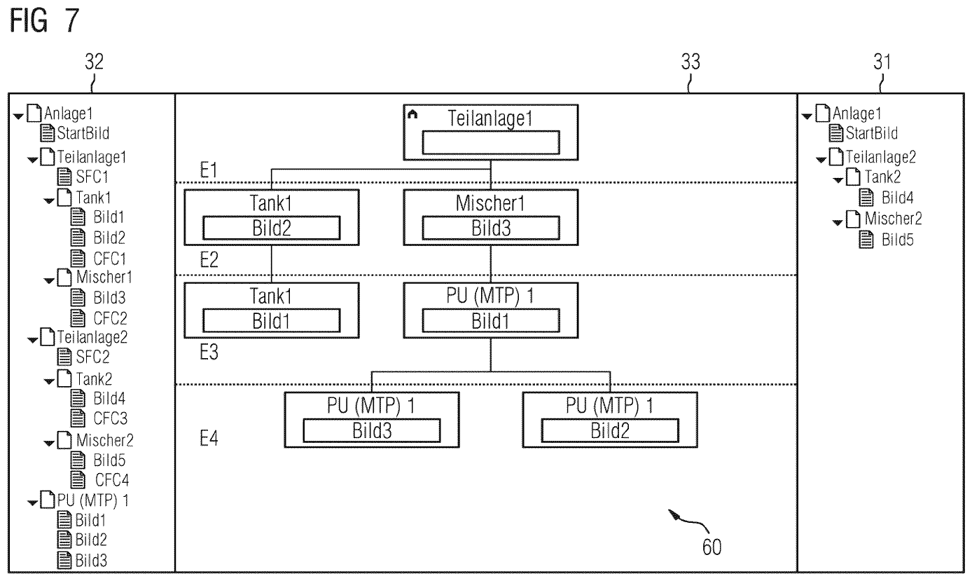

As shown in FIG. 7, the technologically structured list of plant images in the area 31 has thus been further reduced.

In principle, it is also possible to pre-structure all plant images by assigning hierarchy and sequence information accordingly. It is then sufficient to select only the top structure node (here “Plant1”) in the area 31 by clicking on it and placing it in the area 33 using drag & drop. The plant image hierarchy 60 defined by the hierarchy and sequence information is then automatically output in the area 33. This allows maximum efficiency to be achieved when generating the plant image hierarchy 60.

It should be understood that, even if plant images have been pre-structured, the plant image hierarchy 60 can be adjusted in detail at any time in the area 33. The pre-structuring of the plant images, as well as the technological and structural organization in the area 31, is essentially used to ensure efficient “initialization.”

The engineering system 19 has been described in the exemplary embodiment in the form of a client-server architecture.

However, this is not to be understood as restrictive. Other architectures are also possible. For example, the engineering system 19 can also be implemented by a single computer.

In summary, the plant images pre-structured in accordance with disclosed embodiments of the invention enable more efficient and less error-prone generation and project planning of plant image hierarchies, in particular to improve the integration or exchange of modularized plant components via modularized, pre-configured process engineering plant components (package units), in particular MTPs, in hybrid process engineering plants.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A computer-implemented method for generating a plant image hierarchy, in which plant images for operating and observing a process engineering plant to be controlled are stored in a structured manner with regard to hierarchy and sequence and which is selected and opened by an operator during the runtime of the plant, wherein in the structured storage:
the plant image hierarchy comprises at least a first and a second hierarchy level,
plant images of the second hierarchy level are assigned to a plant image of the first hierarchy level,
plant images of the second hierarchy level each assigned to the same plant image of the first hierarchy level are assigned to a sequence forming a sequence with regard to a process engineering structure of the plant, the method comprising:
a) assigning to at least some of the plant images of the second hierarchy level in each case:
hierarchy information with regard to a plant image of the first hierarchy level, and
sequence information with regard to a sequence with regard to other plant images of the second hierarchy level which are assigned to the same plant image of the first hierarchy level, in particular to a sequence with regard to a process engineering structure of the plant, said assignment occurring prior to the structured storage of the plant images;
b) outputting the plant images for selection;
c) recording selection information with regard to a selection of the plant images output in step b) for their subsequent structured interconnection with each other with regard to hierarchy and sequence; and
d) outputting the plant images selected in step c) for subsequent structured interconnection;
wherein plant images with assigned hierarchy information and sequence information are automatically pre-structured according to a respective assigned hierarchy information and sequence information.

12. The method as claimed in claim 11, wherein at least some of the plant images with the assigned hierarchy and sequence information relate to a modularized and pre-configured process engineering plant component comprising a module type package.

13. The method as claimed in claim 11, wherein the plant images are defined by a technological hierarchy of the plant.

14. The method as claimed in claim 13, wherein the plant images are output in step b) in a structured manner in accordance with a technological hierarchy of the plant.

15. The method as claimed in claim 11, wherein the plant image hierarchy is generated in an engineering system; and wherein hierarchy and sequence information is assigned when importing plant images into the engineering system.

16. The method as claimed in claim 11, wherein the selection information is defined by a move operation which is performable by a project engineer.

17. The method as claimed in claim 11, wherein only plant images which are not yet contained in the plant image hierarchy are output for selection in step b).

18. An engineering system for generating a plant image hierarchy, in which plant images for operating and observing a process engineering plant to be controlled are stored in a structured manner with regard to hierarchy and sequence and which is selected and opened by an operator during the runtime of the plant, wherein in the structured storage:
the plant image hierarchy comprises at least a first and a second hierarchy level,
plant images of the second hierarchy level are assigned to a plant image of the first hierarchy level,
plant images of the second hierarchy level each assigned to the same plant image of the first hierarchy level are assigned to a sequence, in particular to a sequence with regard to a process engineering structure of the plant, the engineering system comprising:
at least one processor which is connected to a storage device;
wherein the at least one processor is configured to:
a) assign to at least some of the plant images of the second hierarchy level in each case:
hierarchy information with regard to a plant image of the first hierarchy level, and
sequence information with regard to a sequence with regard to other plant images of the second hierarchy level which are assigned to the same plant image of the first hierarchy level, in particular to a sequence with regard to a process engineering structure of the plant, said assignment occurring prior to the structured storage of the plant images;
b) output the plant images for selection;
c) record selection information with regard to a selection of the plant images output in step b) for their subsequent structured interconnection with each other with regard to hierarchy and sequence; and
d) output the plant images selected in step c) for subsequent structured interconnection;
wherein plant images with assigned hierarchy information and sequence information are automatically pre-structured according to a respective assigned hierarchy information and sequence information.

19. A computer program stored on memory comprising commands which when implemented by a computer cause the computer to perform the method as claimed in claim 11.

20. A non-transitory computer-readable storage medium encoded with comprising commands which, when executed by a computer cause the computer to generate a plant image hierarchy, in which plant images for operating and observing a process engineering plant to be controlled are stored in a structured manner with regard to hierarchy and sequence and which is selected and opened by an operator during the runtime of the plant, wherein in the structured storage:
the plant image hierarchy comprises at least a first and a second hierarchy level,
plant images of the second hierarchy level are assigned to a plant image of the first hierarchy level,
plant images of the second hierarchy level each assigned to the same plant image of the first hierarchy level are assigned to a sequence forming a sequence with regard to a process engineering structure of the plant, the method comprising:
a) assigning to at least some of the plant images of the second hierarchy level in each case:
hierarchy information with regard to a plant image of the first hierarchy level, and
sequence information with regard to a sequence with regard to other plant images of the second hierarchy level which are assigned to the same plant image of the first hierarchy level, in particular to a sequence with regard to a process engineering structure of the plant, said assignment occurring prior to the structured storage of the plant images;
b) outputting the plant images for selection;
c) recording selection information with regard to a selection of the plant images output in step b) for their subsequent structured interconnection with each other with regard to hierarchy and sequence; and
d) outputting the plant images selected in step c) for subsequent structured interconnection;
wherein plant images with assigned hierarchy information and sequence information are automatically pre-structured according to a respective assigned hierarchy information and sequence information.
